(19) United States
(12) Patent Application Publication
(10) Pub. No.: US 2004/0111322 A1
(43) Pub. Date: Jun. 10, 2004

(54) Multi-function transaction processing system

(76) Inventor: Luis A. Arias, Miami, FL (US)

Correspondence Address: MALLOY & MALLOY, P.A., 2800 S.W. Third Avenue, Historic Coral Way, Miami, FL, 33129, US

(21) Appl. No.: 10/637,799

(22) Filed: Aug. 8, 2003

Related U.S. Application Data
(63) Continuation-in-part of application No. 10/120,896, filed on Apr. 11, 2002.
Application No. 10/120,896 is a continuation-in-part of application No. 09/588,917, filed on Jun. 8, 2000, now Pat. No. 6,651,885.

(51) Int. Cl. G06F 17/60

(52) U.S. Cl. 705/16

(57) ABSTRACT

A multi-function transaction processing system a transaction terminal that includes two data entry facilities and a transaction processor, the transaction processor being communicatively associated with a control processor, and the first of data entry facility including a payment authority input structured to accept a payment authority. The second data entry facility includes a customer interface structured to be accessed by a customer, and has a display associated therewith. Furthermore, the transaction processor is responsive to customer inputs via the customer interface of the second data entry facility and is structured to provide the customer with a plurality of selections on the display, the control processor defining a user account in accordance with a customer selection and to issue an authorization code associated with the user account. Preferably the user account includes a defined value defined by said payment authority, said authorization code structured to facilitate a transaction in accordance with the defined value, and a printer assembly communicatively associated with the transaction terminal generates a card assembly bearing the user account information.

### CLAIM OF PRIORITY

The present application is a continuation-in-part application of previously filed, now pending application having Ser. No. 10/120,896 filed on Apr. 11, 2002, which is a continuation-in-part application of previously filed, now pending application having Ser. No. 09/588,917, filed on Jun. 8, 2000.

### BACKGROUND OF THE INVENTION

1. Field of the Invention

The present invention relates to a multi-function transaction processing system which many be disposed at a commercial location in order to complete a variety of commercial transactions, including credit/debit card purchases, while also facilitating one or more alternate, commercially advantageous functions including the issuance of authorization codes for purposes related to pre-paid telephony service, Internet purchases, lottery purchases, and the like, without having to have a pre-selected inventory on hand. Moreover, the present transaction processing system is configured to be accessed my multiple users, preferably including a customer and an attendant so as to provide the customer with substantial freedom and flexibility to select and customize a desired product, such as the authorization code, while also achieving attended consummation of the transaction which increases purchase flexibility and security. Accordingly, a customer may have a very large variety of potential selections available to them in an easy to identify and substantially current manner that does not take up excessive inventory space, and does not require the merchant to choose between more or less popular selections.

Furthermore, the multi-function transaction processing system provides an effective source for the dissemination of a variety of promotional materials in connection with the transaction being completed utilizing the system and is configured to produce and issue a customized card to a particular user with minimal printer error and account losses.

2. Description of the Related Art

With the ever increasing popularity of credit or debit card payments at commercial establishments, it is becoming increasingly commonplace to find small credit card transaction terminals at commercial establishments such as grocery stores, gas stations, convenience stores, and the like. Typically, these conventional credit/debit card transaction terminals are linked to an affiliated service so as to provide for the approval of a particular transaction, thereby facilitating payment to the merchant. Such traditional transaction terminals are, however, limited to providing authorization for a particular purchase in lieu of a cash payment for products or services that are normally offered by the merchant. As a result, while they are a convenience for the operators of commercial establishments, they do not provide any added commercial advantage to the commercial establishment. Indeed, the convenience factor is generally the only factor to offset the service fees that must typically be paid by the commercial establishments to the authorizing entity. As a result, it would be beneficial to provide an enhanced transaction terminal as part of a transaction system, which in addition to facilitating traditional credit\debit card purchases, will also provide an added source of economic benefit for the commercial establishments employing such a system, directly as a result of its use.

An example of an added source of revenue that has become increasingly popular for merchants includes the calling card industry, wherein a particular commercial advantage is being attained from the sale of pre-paid calling cards. Specifically, such pre-paid calling cards are typically supplied in bulk to a retail establishment where they may be sold at specific monetary denominations. In essence, each pre-paid, pre-printed calling card provides a purchasing consumer with the appropriate access to a defined amount of telephony connection time. As a result, the consumer, often at a reduced rate, is able to initiate any desired telephony communication from any telephone, without incurring toll or other service charges in connection with that telephone.

Despite advances in the calling card industry, it is often commercially limiting to provide the physical cards to the commercial or retail establishments for appropriate sale to the consumers. For example, if sales are slow at a particular location, an inventory of cards will remain unused and unsold, The fact that a finite amount of air time is purchased by the operators of the card requires that the time remain un-used in case a purchase does indeed occur with regard to a pre-printed account. Conversely, an establishment which makes a large volume of sales may run out of cards and future potential sales will be lost as no cards are available. Yet another inconvenience associated with traditional pre-printed calling card relates to the need for inventory space to store large volumes of physical cards, naturally resulting in added expense, and the fact that the cards, once printed, cannot be changed if retail identity, rates, etc., change, and provide an actual commodity susceptible to theft or other misappropriation.

Furthermore, it is also recognized that with increased globalization and competition in the market, there are a substantial number of alternative products that are now available to consumers. For example, in the pre-paid calling card industry, there are a variety of plans available based upon a number of factors including typical duration of call, call destination, call origination location, etc. As such, a plan that is most desirable to a consumer who makes a majority of there calls to one location may not be the most desirable to a consumer that places calls to many different locations. Accordingly, utilizing conventional systems a user has limited choices and truly cannot explore, take advantage of, or identify the best option from a large sampling. It is also noted that despite the desirability to have an attended transaction processing system in many instances, an attendant often does not have sufficient time or knowledge to assist a consumer by explaining or presenting to them a variety of options.

It is recognized that others in the art have sought to develop individual card printing devices. Specifically, such devices are generally standard printing devices that print a particular calling card on demand, thereby minimizing the space and inventory requirements of the commercial establishments and permitting at least a degree of variability, such as in connection with card denominations. Unfortunately, however, such systems are still severely limited, as each card printing terminal is provided with a finite number of plans and access codes to be printed on a finite number of calling cards. Typically, a quantity of the access codes are downloaded into the individual terminal at a predetermined period of time, in much the same manner that traditional cards are stocked at the establishment. As a result, the information and the plans cannot be readily updated and these existing devices do not alleviate the problems associated with outstanding, unsold access codes/pin numbers, or the loss of sales after depletion of an initially defined volume of cards. Furthermore, such terminals are merely printers which print a number of a cards, and they do not provide any further business enhancing qualities or functions which provide a commercial advantage to the establishment utilizing the terminal, beyond merely the sale of a small selection of calling card. Moreover, it is also recognized that whenever an attempt to customize the appearance of a particular card is made, significant losses to missprints and the like can occur. For example, if a card stock is provided with indicia on one face and a printable surface on an opposite face, improper introduction of a stock card into the printer will result in either an illegible print and/or the failure of a thermal type printer to print anything on the card. Still, however, under such circumstances the authorization code has been generated and issued, and the printing of a new card results in the issuance of a new authorization number. In such a situation, even if the transaction is voided, the authorization number is used and remains ‘open’ in the control system. Naturally such can be very costly and inconvenient to service providers as they often deal with finite number blocks of authorization numbers and it is not practical to have a large number of outstanding numbers which the service provider cannot distinguish between actually purchased, but yet unused cards versus misprints.

Accordingly, there is still a need in the art for a calling card system which does not have to be limited in terms of quantities sold, allows for complete card versatility, and ensures that proper utilization of all resources is maintained without waste, improper printing or storage problems. Additionally, such a transaction system should provide enhanced functionality so as to provide a variety of commercially advantageous services/products for a particular establishment, providing consumer incentive for the calling card purchases and to providing a mechanism via which the costs associated with the calling card to the retail or distributor can be offset through the association of alternative commercial endeavors, such as promotions and other services. Also, such a transaction system should be easy and convenient to interact with by a consumer, providing the consumer with updated information and a large number of selections and information, while still providing for attendant control and coordination of certain vital features such as payment processing and actual card issuance, if desired.

The present invention also recognizes that given the advances of global computerized network communications and commerce, increased purchase avenues are continuously being made available to consumers. Unfortunately, however, many traditional consumers still have security concerns associated with consummating such electronic transactions, especially if they will be required to transmit credits/debit card information to the merchant. In some circumstances, privacy concerns also restrict a consumer's desire to make certain purchases by traditional means. As a result, it would be beneficial to provide a transaction system which is capable of offering prepaid services which can not only be utilized for such traditional services as telephony communication, but which also provides a means through which a consumer can establish a prepaid purchase, utilizing that pre-payment for any of a variety of products or services.

### SUMMARY OF THE INVENTION

The present invention is directed to a multi-function transaction processing system. The transaction processing system includes a transaction terminal that may be disposed at any establishment, including a commercial or retail type establishment. In particular, the transaction terminal includes a pair of data entry facilities and a transaction processor associated therewith. Moreover, the transaction processor, which facilitates a variety of the operational functions of the transaction terminal, is communicatively associated with a control processor.

The first data entry facility associated with the transaction terminal includes a payment authority input which accepts a payment authority, such as a credit card transaction or acknowledgment of cash payment. In this regard, the first data entry facility is preferably disposed to be utilized by an attendant at a particular location. As for the second data entry facility, it preferably includes a display operatively associated therewith, as well as a customer interface structured to be accessed by a customer. Preferably the second data entry facility is also operatively associated with the transaction terminal. In this regard, the transaction processor is structured to be responsive to customer inputs made via the customer interface, and thereby provides the customer with a plurality of selections on the display.

Communicatively associated with the transaction processor is a control processor. The control processor is structured to define a user account in accordance with a user selection, and to issue an authorization code associated with the user account. Preferably the user account includes a defined value that is at least partially defined by the payment authority. As a result, the authorization code facilitates the subsequent transaction in accordance with that defined value, while the control processor provides necessary confirmations or validations.

The transaction processing system of the present invention may also include a printer assembly. The printer assembly is communicatively associated with the transaction terminal and is structured to at least generate a card assembly. In the illustrated embodiment, the card assembly may be generally elongate, including one or more portions, as well as a first face and a second face. For example, a first portion of the card assembly many include at least the authorization code thereon, while a second portion of the card assembly many include promotional materials thereon. As such, when a consumer completes an appropriate transaction where an authorization code is required for a particular future transaction, the consumer will be provided with the card assembly to facilitate their maintenance and/or conveyance of the authorization code. Conversely, the second portion may include promotional materials which can be distributed to the consumer and provides an incentive for consumer purchase. Also, it may be preferred that all of the information, including the authorization code and any promotional materials be printed on one of the two faces of the card assembly, thus allowing for single sided printing. Moreover, such an embodiment permits the card assemblies to be pre-printed with a logo or other indicia affiliated with the merchant or service provider on the opposite face.

In order to prevent the waste of authorization codes that may result form the improper printing of a card assembly, the card assemblies also preferably include an indicator which is structured to provide an identifiable indication to the printer as to whether the card assembly is properly oriented relative thereto. As such, if the card assembly is not properly oriented and will not print properly, the indicator will prevent the printer assembly from completing the printing and may signal an alert to a user that the card should be re-oriented.

These and other features of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective illustration of an embodiment of the transaction terminal and printer assembly associated with the system of the present invention;

FIG. 2 is a illustration of the card assembly of an embodiment of the present invention;

FIG. 3 is a perspective illustration of another embodiment of the multi-function transaction processing system of the present invention; and

FIG. 4 is an illustration of one embodiment of the card assembly including the indicator thereon.

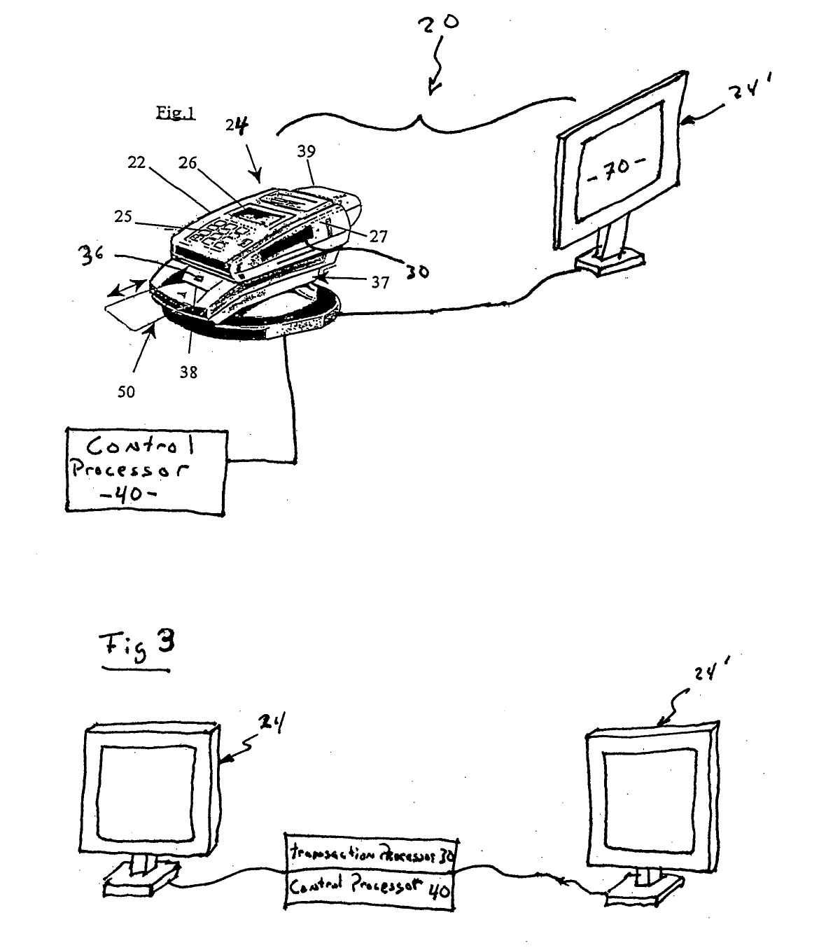

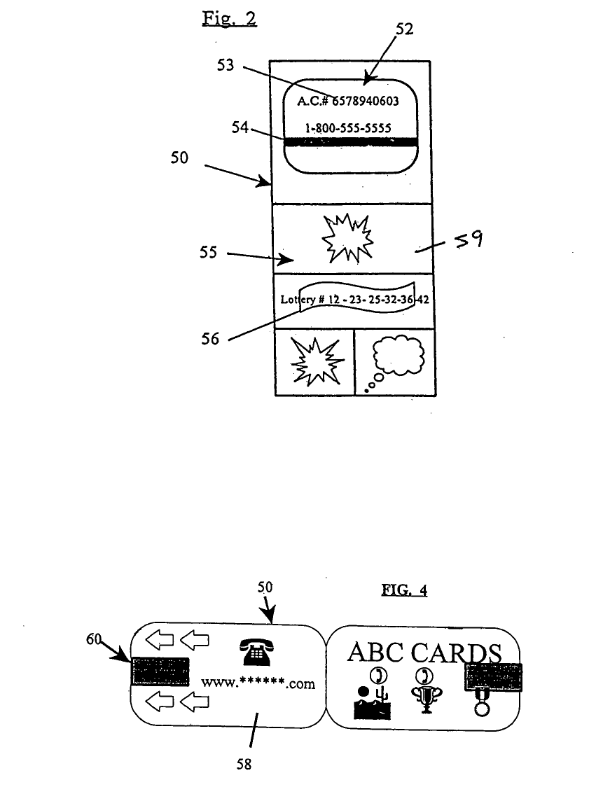

Like reference numerals refer to like parts throughout the several views of the drawings.

### DETAILED DESCRIPTION OF THE PREFERRED EMBODIMENT

As illustrated in the figures, the present invention is directed to a multi-function transaction processing system, generally indicated as 10. The transaction processing system 10 is structured to coordinate and facilitate a variety of different transactions in an efficient and integrated manner which provides an increased commercial benefit beyond what is normally available to a merchant utilizing the transaction processing system 10.

Looking to an embodiment of the transaction processing system 10, as illustrated in the figures, the transaction processing system 10 includes at least one transaction terminal 20. The transaction terminal 20 can be generally compact and convenient to position within a facility, such as secured directly to a checkout counter or similar location. In this regard, it is recognized that the transaction terminal 20 is preferably configured and positioned so as to permit its use directly or interactively by a consumer/customer, while also allowing for convenient and effective use by an authorized attendant, such as the merchant, to complete the desired transactions.

The transaction terminal 20 includes at least two data entry facilities 24, 24′ and a transaction processor 30. The first and second data entry facilities 24, 24′ may include one or more of a variety of conventional input facilities, including a keypad 25 which may be separate or integrated as part of a touch screen, a magnetic stripe reader 27 through which a credit or debit card many be passed, and/or any other data entry facility such as a bar code scanner or other scanning device. Looking to the illustrated embodiments, the first data entry facility 24 preferably includes a small terminal type station structured to be easily accessed and actuated by an attendant. In this regard, it is noted that the first data entry facility may be in an isolated location, such as behind a counter or partition, or may be disposed so as to ultimately be accessible to the consumer as well for certain aspects of the transaction. For example as will be described subsequently, the first data entry facility 24 may include a signature capture structure and/or keypad for the entry of a security number to facilitate payment. Of course, these interactive security entry items may be provided in connection with the second data entry facility 24′ as well or instead of on the first.

Looking to the preferred second data entry facility 24′, it preferably includes a customer interface and at least one display operatively associated therewith. Although it is recognized that the second data entry facility 24′ may be much the same as the illustrated first data entry facility 24, in the illustrated embodiment, the second data entry facility 24′ preferably provides for greater ease of use and interactivity than the first data entry facility 24. As such, the second data entry facility 24′ may include a larger touch screen type configuration capable of providing the customer with large amounts of information and selections, and achieve a very easy and intuitive selections process by the consumer. As such, a screen 70 is preferably positioned to define both the display and the customer interface. Moreover, the second data entry facility 24′ is preferably oriented towards a different direction than the first data entry facility. For example, in the illustrated embodiment the first data entry facility 24 is positioned to be more easily accessed by an attendant, whereas the second data entry facility is positioned to be more easily accessed by the customer. This differing positioning also allows the second data entry facility 24′ to be positioned at a more remote or convenient location that is out of the way of the attendants work area, such as a check out counter. A customer can therefore take their time making necessary selections and need not block the main counter area of a merchant facility, thus allowing the attendant to take care of other customers while the customer seeking to purchase an article in connection with the present transaction terminal 20 can take their time. Indeed, it is preferred that the transaction processor 30 be structured to provide a user with a plurality of selections.

In particular, in a preferred embodiment of the present invention, the customer will utilize the present system 10 to purchase pre-paid calling cards. As such, the transaction processor will preferably provide the user with a large number of choices via the second data entry facility 24′ in order to allow the user to truly choose a card that suits them best. For example, often some cards have better of different rates than others to certain locations, and as such, a more generic card may not be optimal for the customer. By having information regarding a plurality of selections available, and waiting, as will be described to print an actual card in response to customer selections, a much larger stock and selection pool of products and product denominations can be provided. Furthermore, it may be desirable that said transaction processor make a number of inquiries of the customer via the second data entry facility 24′ so as to ultimately guide and/or aide the users selection process, and minimize confusion and/or delay to the customer based upon the large number of selections.

Preferably, but not necessarily included as part of one or more aspects of the first data entry facility 24, and in some embodiments all or partially as part of the second data entry facility 24′ is a payment authority input by which a payment authority may be received and/or communicated to the transaction processor 30. As such, any of the previously mentioned types of the data entry facility 24. 24′ many qualify as the payment authority input, although in the illustrated embodiment the payment authority input includes the keypad 25 and the magnetic stripe reader 27 associated with the first data entry facility 24. Additionally, in the illustrated embodiment, one or both of the data entry facilities 24, 24′ may also include an electronic signature capture assembly, such as integrated as part of a display assembly 26 or touch screen 70. Specifically, such an electronic signature capture assembly 26 is structured to permit a consumer to make an electronic signature directly thereon, thereby avoiding the needed for a carbon receipt to be signed by the consumer, and eliminating the need for a merchant to maintain paper receipts of purchases.

As such, utilizing one or more of the different types of data entry facility 24, 24′ configurations recited, a consumer is able to provide a desired payment authority at the transaction terminal 20, which is then communicated to the transaction processor 30. For example, if the consumer wishes to make a purchase from the merchant utilizing the transaction terminal 20, they may pay cash in a traditional fashion or may provide a credit or debit type card to the merchant. The merchant is then able to provide credit card transaction information as the payment authority, such as by keying in the appropriate credit card transaction information and/or passing an appropriate card through the magnetic stripe reader 27. In the illustrated embodiment the credit card transaction information includes at least a credit card account and a transaction amount as the payment authority. It is, however, recognized that the credit card transaction information may include additional information, such as credit card expiration date. Moreover, although for purposes of clarity and ease of explanation reference is being made to a credit card transaction and credit card transaction information, it is understood that a check card, smart card, debit card, check or other similar account payment method may be employed in a conventional fashion, the credit card transaction information including the necessary information for processing a particular purchase, sale or transaction in accordance with the payment account selected.

In addition to receiving credit card transaction information as the payment authority, however, the illustrated embodiment of the present invention may also receive an external payment verification, at least partially as the payment authority. Specifically, and for reasons to be described subsequently, a consumer may make a cash or credit card purchase separate from the transaction terminal 20, but may wish to have a further receipt, authorization, promotional item, completion of a further transaction facilitated by the transaction terminal 20. In such an embodiment, preferably utilizing the keypad 25 as the payment authority input, although it is recognized that alternative payment authority inputs, including a direct link to a transaction computer, cash register, or more traditional credit card authorization device may also be employed, an input related to the external payment verification is provided. For example, if the consumer desires to pay cash, the payment authority can be appropriately entered into the transaction terminal 20 as the external payment verification. In such an embodiment the external payment verification indicates the nature and extent of the external payment and, if desired for security reasons, the transaction processor 30 may require an access authorization in connection with the external payment verification. As such, a validity of the external payment verification can be ensured. The access authorization may include, for example, any access code or other security verification including a key, key card, personal identifier, etc., may be provided as the access authorization, an authorized individual associated with the merchant properly providing the access authorization to indicate that the external payment verification is indeed valid and is backed by the external transaction.

The transaction processing system 10 of the present invention also includes a control processor 40. The control processor 40 is communicatively associated with the transaction processor 30 of the transactional terminal 20, and may integrally defined as part thereof subject only to updating as needed, especially if credit card purchases will be separately verified, or ay be defined as a separate and often remote structure as in the illustrated embodiment of FIG. 1. In this embodiment, it is recognized that one or more control processors 40 may be provided and locally or remotely communicatively associated with one or a plurality of transaction processors 30, a large network of transaction terminals 20 being contemplated. Moreover, the communicativity, as at 35, that is established between the transaction processor 30 and the control processor 40 is preferably two way, and may be achieved through any of a variety of structures, including a dedicated connection, a network type connection, a wireless connection, an Internet connection and the like, so long as at least some degree of preferably secure data transmitting communication may be achieved. Along the these lines, the transaction processor 30 is structured to communicate the payment authorities received at the transaction terminal 20 to the control processor 40. Moreover, in some instances, such as with a conventional credit card transaction, the control processor 40 is structured to validate and/or authorize the payment authority, such as by verifying the credit card account information or ensuring that the access authorization associated with an external payment verification is a valid.

The control processor 40 is also structured to define a user account and to issue an authorization code associated with the user account, such as for the benefit of a consumer in connection with a further transaction, to be described. Generally, the authorization code and user account are defined by the control processor 40, at least partially in response to the payment authority received at the transaction terminal 20. Furthermore, the user account defined by the control processor 40 may include a defined value, such as a dollar value or transaction quantity/frequency value, which is also at least partially defined by the payment authority. As a result, the authorization code issued by the control processor 40 is structured to facilitate a transaction in accordance with the predefined value of the user account for which the authorization code was issued. Additionally, the authorization code and customer account defined by the control processor 40 are also preferably defined in response to the user selections that were made utilizing the second data entry facility 24′. In this regard, the customer may make an actual selection using the second data entry facility 24′, that selection being communicated to the transaction processor 30 and ultimately the control processor 40, or the customer may be given a code to be presented to the attendant that corresponds a desired selection. For example, in a preferred embodiment the customer reviews the various selections and then makes a selection using the customer interface. The selection made by the customer can then be immediately communicated to the transaction processor or can be placed in a cue, and possibly assigned a cue number, such as if an attendant is handling other transactions using the first data entry facility 24 or if the customer makes there selection but then must wait in line for the attendant. Then preferably pending entry of a satisfactory payment authority, either by the attendant at the first data entry facility 24 or the customer at the first or second data entry facilities 24, 24′ the purchase can be processed and the customer account defined by the control processor 40. It is with reference to such a transaction that one can illustrate an integral control processor 40 wherein a batch or store of user accounts and/or authorization codes can be pre-stored in a local control processor, and then issued from that defined, and preferably periodically updated cache. Still, however, it is preferred that all or part of the control processor 30 be remote such that the most up to date information can be provided to the customer as their selection options, and such that certain codes are not held out of use.

Under any such embodiment, it is preferred that the control processor 40 communicates the authorization code to the transaction terminal 20 for communication to the consumer, if necessary and/or as necessary. In particular, although the authorization code defined by the control processor 40 may be communicated to a consumer in a variety of fashions, such as merely by illustrating it on the display assembly 26 of the transactional terminal 20, in the illustrated embodiment, the multi-function transaction processing system 10 also includes a printer assembly 37 through which at least a printout of the authorization code may be provided for the consumer. Specifically, the printer assembly 37 may be communicatively associated with the first data entry facility 24 or any other portion of the transaction terminal 20, but is preferably structured to be under the control of an attendant. In the illustrated embodiment, the printer assembly 37 is structured to generate a card assembly 50. The card assembly 50, which may be constructed of a generally thick card stock type material, may also be generally elongate, as illustrated in FIGS. 2 and 4, so as to define a greater amount of information receiving surface area. Of course, however, it is recognized that although physical printing of the authorization code 53 on the card assembly 50 is to be described in connection with the illustrated printer assembly 37, other types of printed encoding, such as the making of encoded markings or the appropriate encoding of a magnetic stripe 54, or other data storage structure on the card assembly 50 may also be utilized and are considered within the scope of the present description of printing. In the illustrated embodiment, the card assembly 50 includes at least a first portion 52 and a second portion 55. The first portion 52 includes the authorization code 53 thereon, such as in the form of printing of the authorization code directly on the first portion 52. Additionally, in the case of a telephony communication transaction, as will be described, a telephony access number may also be disposed on the first portion 52 of the card assembly, the telephony access number to be utilized to initiate the telephony communication with a telephony server. Furthermore, so as to facilitate usage of the first portion 52 of the card assembly 50 in a manner similar to conventional prepaid calling cards, the first portion 52 may be detachable from the second portion 55, thereby permitting the first portion 52 to be substantially compact such as in the form of a credit card or similar sized structure, or in the form of a smaller structure such as may be hung from a key chain. Also, as seen in FIG. 2, one or more aspects of the card assembly 50 may be provided on a magnetic stripe 54 or other encoded structure in addition to or instead of direct printing on the surface of the card assembly 50.

Looking to the second portion 55 of the card assembly 50, among other items, it preferably includes promotional materials disposed or depicted thereon. Specifically, the promotional materials may include coupons, advertisements and/or a variety of other promotional articles which may be attractive to a consumer, or which a merchant may wish to promote to consumers obtaining an authorization code for a desired transaction. As such, the merchant, distributor or other individuals associated with the transaction terminal 20 may, if desired, achieve an additional source of revenue through payments or offsets from the source(s) of the coupons and or advertisements depicted by the second portion 55 of the card assembly 50. This also, provides an added value to the consumer of the card assembly 50 through the additional promotional items, discounts and the like, thereby adding increase incentive to purchase such a card assembly over other competing products.

Also, turning to FIG. 4, it is noted that the card assembly 50 includes a first face 58 and a second face 59. In one preferred embodiment, the first face 58 has a quantity of pre-printed materials thereon, such as an identification of the type of product being sold and/or a logo of a merchant or service provider. In this respect, a pre-designed card stock can be provided and maintained for use when a user desires to purchase a specific brand card assembly 50. In such an embodiment, the second face 59 of the card assembly is at least partially blank and/or otherwise designed so that the printer assembly 37 can print the corresponding items, such as the authorization code thereon, at a time of purchase. Such a configuration may also allow for different branding opportunities, even from the same transaction terminal 20.

Looking in further detail to the specific embodiment of the printer assembly 37 illustrated in FIG. 1, it is preferably generally elongate, and is formed in association with a remainder of the transaction terminal 20. In this regard, the printer assembly 37 may in include an elongate, generally planar slot 38, through which the elongate, potentially stiff card assembly 50 is passed for appropriate printing thereof. Although, it is recognized that in the case of more conventional transactions, or even in most transactions when a consumer desires to have a receipt of their transaction, the printer assembly 37 may also be utilized for that purpose, such as by printing appropriate receipt information directly on a portion of the card assembly 50 or on a separate document. In the embodiment illustrated in FIG. 1, however, a receipt printer 39 may also be provided. The receipt printer 39, which may be considered part of the overall printer assembly, is structured to print a receipt associated with an authorized transaction for the consumer and as a result need not be provided directly on the card assembly 50. In such an embodiment, the receipt printer 39 is as at least partially distinct from the printer assembly 37. As mentioned, however, and still with reference to FIG. 1, in addition to or instead of the distinct receipt printer 39, the printer assembly 37 may include the receipt printer directly as a part thereof, such as through a separate paper feed, printing directly on the card assembly 50, or requiring a conventional paper stock for the purposes of issuing a more traditional receipt before or after printing of the card assembly 50 and for completion of a desired transaction.

The printer assembly 37 may include any of a variety of different types of printers, however, a thermal type printer configured to print on specially coated and/or configured paper is preferred. Moreover, it is recognized that in some embodiments wherein the card assembly 50 includes the first face 58 with the pre-printed materials thereon and the printer assembly accomplishes one side printing, it is important to ensure that the card assembly 50 is properly introduced into the printer assembly 37 so that the printer assembly 37 will not attempt to print the important information on the pre-printed, first face 58. Indeed, in the case of a thermal printer, the printing process may actually occur, but if it is performed on the pre-printed side and/or an untreated side, no legible printing will ultimately appear and an operator is left without knowing whether a printer malfunction occurred and a specific transaction was actually completed, or whether another malfunction occurred and the transaction was not actually completed. The operator may therefore be left with little choice but to void the first transaction, and issue a new card, often thereby wasting an authorization or account number. In order to prevent such an occurrence the card assembly 50 may preferably include an indicator assembly 60 thereon. The indicator assembly, which may be disposed on the first or second faces of the card assembly 50 preferably functions in association with the printer assembly 37 so as to allow for effective determination of the orientation of the card assembly 50 by the printer assembly 37, and thus preventing printing if the card assembly 30 is not properly oriented. In the illustrated embodiment the indicator 60 is disposed on the first face 58 and includes a minimally reflective mark, such as a black or generally opaque stripe disposed on the card assembly 30.

Furthermore, the printer assembly includes a correspondingly disposed sensor 36. The sensor 36 is structured to effectively identify said indicator 60 and to thereby determine if the card is properly oriented for printing. In the preferred, illustrated embodiment, the sensor 36 is structured to emit a light beam and detect a reflection thereof. Naturally, if the light beam is directed to the indicator, minimal amounts of light, if any will reflect, and the presence of the indicator can be determined. Naturally, the sensor 36 can be configured to interact with the first and/or the second face of the card assembly 30, and it can be configured such that the detection of the indicator 60 is indicative of proper or improper orientation of the card assembly 30.

It is also noted, that by associating the printer assembly with the first data entry facility 24, the printing process is an attended process and error minimization is achieved, such as if the printer sensor is not included. Furthermore, various stocks of blank cards may also be provide, the attendant selecting an appropriate card, such as for marketing or promotional reasons, and or to correspond the specific type of customer account ultimately selected by the customer.

As indicated, the control processor 40 is structured to receive information relating at least to a payment authority from the transaction processor 30. In the case of a point of sale purchase of goods or services, the control processor 40 may only communicate an appropriate authorization to the transaction terminal to complete the point of sale purchase. In other embodiments, however, when an authorization code is desired for supporting another, typically subsequent transaction, the control processor 40 defines the user account. Along these lines, it is noted that when the control processor 40 defines a user account, a new user account may be provided in connection with each authorization code, or in some instances, an existing user account may be utilized, such as by re-filling. In either instance, however, each user account is associated with a specific type of account, such as a specific calling/card plan, and includes its defined value, whether the defined value begins at zero with the formation of a new user account or is at a defined amount already. The control processor 40 then adds to that defined value an amount defined at least by an authorized payment authority received from the transaction processor in connection with that user account. For example, if payments for point of sale purchases are not involved and a consumer's sole purpose is to obtain an appropriate authorization code for a new user account, or merely to add to an existing user account, a substantial component, if not all of the payment authority will usually be added to the value of the user account. In this regard, it is recognized that processing fees, service fees and the like many be deducted, such that a payment authority for a certain amount will not precisely correspond to the value added to the user account. Conversely, in connection with certain promotions, the value of the user account may be increased by an amount greater than the actual payment authority, such as in connection with an incentive plan where a payment authority of a certain larger amount entitles the consumer to a greater value increase to the user account (i.e. a $20 purchase gives $25 worth of credit).

As mentioned, although a variety of different transactions may be achieved in connection with the issued authorization code, in one embodiment of the present invention the transaction that is facilitated by the authorization code includes a telephony communication. As a result, pre-paid service is established and an extent of the telephony communication(s) available is limited by the defined value and type of user account associated with the authorization code. As mentioned, in such an embodiment a telephony access number is also provided to the user, such as on the card assembly 50, and may in include a toll-free or similar access number which initiates communication with a telephony server. Whether the telephony access number and or the authorization code are merely viewed on the display assembly 26 or are provided on the card assembly 50 by the printer assembly 37, a consumer utilizes the authorization code and telephony access number in connection with an auxiliary device, such as a computer or telephone, so as to communicate with a telephony server. The telephony server in turn communicates with the control processor 40. Specifically, the auxiliary device, such as including the telephone and/or telephony server receives the authorization code and through communication with the control processor 40 is able to identify the user account and the defined value of the user account. Accordingly, the telephony server is able to determine the extent of the telephony communication that can be permitted and which has been paid for. Along these lines, it is recognized that the auxiliary device including possibly the telephony server may be separate or part of the control processor 40, and if separate, may communicate with the control processor 40 in order to verify the validity of an authorization code in any manner. Therefore, a consumer, by purchasing the card assembly 50, is a given the requisite authorization code 53 and telephony access number so as to obtain pre-paid telephony communication services, while also receiving the second portion 55 of the card assembly 50 which may include one or more different promotional items thereon. Morever, a consumer is provided with incentive to purchase the particular card assembly 50 of the merchant over other more traditional calling cards that do not provide any added benefit to the consumer.

In yet another embodiment, and either instead of or in addition to the telephony communication, the transaction that is facilitated by the authorization code may include a lottery purchase. In particular, the control processor 40 may store a predefined quantity of lottery entries and/or types of lottery games, in connection with a corresponding lottery commission, and preferably, but not necessarily pre-selected, random number lottery entries. As such, when an indication is made in connection with a payment authority that a lottery purchase is desired, the control processor 40 is able to issue at least one lottery entry 56 in response to the lottery purchase. In this regard it is recognized that the lottery entry 56 may be placed directly on the card assembly 50, such as on the second portion 55, or in some embodiments on the first portion of the card assembly 50 as the actual authorization code. Furthermore, if the control processor 40 is associated with an auxiliary device such as a lottery printing device, the authorization code and/or one or more authorization code's may be provided to the user, either on the display assembly 26 or on the card assembly 50, for presenting in connection with the auxiliary device, thereby allowing the user to retrieve a more traditional lottery entry.

In yet another embodiment of the present multi-function transaction processing system 10, the transaction that is facilitated by the authorization code may include a purchase. Specifically, the purchase transaction may be facilitated either instead of or in addition to one or more other transactions such as the telephony communication. As such, it is recognized that one or more authorization code's may be provided to a consumer in connection with one or more payment authorities at the transaction terminal 20. In such an embodiment, the amount of the purchase that may be facilitated utilizing the authorization code is limited by the defined value of the user account associated with the authorization code. Additionally, a remote transaction processor may be provided, such as part of an auxiliary device, or integrated directly with the control processor 40. The remote transaction processor is structured to receive the authorization code from the user in connection with a purchase, and as an alternate means of payment for the purchase. For example, if a consumer desires to make an Internet purchase, the consumer will be able to communicate the authorization code to a participating merchant. In this regard, the authorization code provided by the consumer may authorize a specific defined amount corresponding the desired purchase or may authorize a number of purchases up to the defined value of the user account associated with the authorization code. As such, the control processor 40 is further structured to authorize the purchase in accordance with the authorization code and the associated account value without the need to provide access to personal information associated with the user making the purchase. Indeed, the user making the purchase is able to maintain a substantial degree of anonymity and security with regard to their credit card information, while still being able to achieve the desired purchase. Moreover, a consumer without access to credit is able to make a cash purchase over the internet or telephone by providing an appropriate payment to a merchant having a transaction terminal 20, and through the entry of an external payment verification, obtaining an authorization code that may be communicated in connection with the telephone or internet purchase.

The control processor 40 of the present invention is also preferably structured to maintain records of an activity of the transaction processor 30 and/or communications between the transaction processor 30 and the control processor 40. As a result, a merchant utilizing the transaction terminal is able to obtain records of payment authorities authorized and communicated to the control processor 40, and can identify the effectiveness of the transaction terminal 20 through its activity and through information relating to additional commercial transactions that are promoted by the transaction terminal 20. In this regard, it is recognized that either directly through the transaction terminal 20 or through other conventional means, such as a network interface, communication with the control processor 40 and/or its operators, such as by e-mail transactions and the like, can be achieved, thereby providing the user with substantial account and record keeping information and usage reports. Additionally, the transaction terminal 20 may be provided to a merchant in connection with a plurality of bundled services, such as personal long distance telephone access for use in the operation of the business, Internet access, electronic mail facilities, and the like, thereby providing an overall, beneficial package of services for the merchant.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A multi-function transaction processing system comprising:
a) a transaction terminal, said transaction terminal including at least two data entry facilities and a transaction processor;
b) said transaction processor of said transaction terminal being communicatively associated with at least a control processor;
c) a first of said data entry facilities including a payment authority input structured to accept a payment authority;
d) a second of said data entry facilities including a customer interface structured to be accessed by a customer;
e) at least one display associated with said second data entry facility;
f) said transaction processor responsive to customer inputs via said customer interface of said second data entry facility and structured to provide the customer with a plurality of selections on said display;
g) said control processor structured to define a user account in accordance with a customer selection and to issue an authorization code associated with said user account;
h) said user account including a defined value at least partially defined by said payment authority, said authorization code structured to facilitate a transaction in accordance with said defined value; and
i) a printer assembly communicatively associated with said transaction terminal and structured to generate a card assembly.

2. A multi-function transaction processing system as recited in claim 1 wherein said card assembly includes at least a first portion and a second portion, said first portion including at least said authorization code thereon and said second portion including promotional materials.

3. A multi-function transaction processing system as recited in claim 1 wherein said first data entry facility is structured to be interfaced by an attendant.

4. A multi-function transaction processing system as recited in claim 3 wherein said first data entry facility is oriented towards a different direction than said second data entry facility so as to facilitate simultaneous utilization of said transaction terminal by the customer and the attendant.

5. A multi-function transaction processing system as recited in claim 4 wherein said printer assembly is oriented towards said first data entry facility so as to provide said card assembly to the attendant accessing said first data entry facility.

6. A multi-function transaction processing system as recited in claim 1 wherein said second data entry facility includes said display.

7. A multi-function transaction processing system as recited in claim 6 wherein said display includes a touch screen.

8. A multi-function transaction processing system as recited in claim 1 wherein said control processor is remotely connected with said transaction processor.

9. A multi-function transaction processing system as recited in claim 1 wherein said control processor is locally contacted with said transaction processor.

10. A multi-function transaction processing system as recited in claim 1 wherein said control processor is included in said transaction terminal.

11. A multi-function transaction processing system as recited in claim 1 wherein said user account comprises a pre-paid telephony account.

12. A multi-function transaction processing system as recited in claim 11 wherein said plurality of selections provide to the customer by said transaction processor comprise pre-paid telephony plans, said customer inputs structured to identify said plan that corresponds said customer selection.

13. A multi-function transaction processing system as recited in claim 12 wherein said transaction processor is structured to query the customer so as to elicit said customer inputs and facilitate identification of a preferred one of said customer selections.
